(19) United States
(12) Patent Application Publication
(10) Pub. No.: US 2019/0256984 A1
(43) Pub. Date: Aug. 22, 2019

(54) COATED ALLOY SUBSTRATES

(71) Applicant: HEWLETT-PACKARD DEVELOPMENT COMPANY, L.P., HOUSTON, TX (US)

(72) Inventors: YA-TING YEH, TAIPEI CITY (TW); KUAN-TING WU, TAIPEI CITY (TW); SHIH-HSUN HUANG, TAIPEI CITY (TW)

(21) Appl. No.: 16/325,482

(22) PCT Filed: Oct. 26, 2016
(86) PCT No.: PCT/US2016/058854

§ 371 Date: Feb. 14, 2019

(51) Int. Cl. C23C 28/00; B32B 15/04; C23C 28/04; C25D 11/24; C25D 11/30

(52) U.S. Cl. CPC C23C 28/345; B32B 15/043; C25D 11/30; C23C 28/322; C25D 11/24; C23C 28/04

(57) ABSTRACT

Examples relating to coating an alloy substrate are described. For example, techniques for coating a surface of the alloy substrate with a coating layer and an exterior coat include anodizing an alloy substrate to form a metal oxide layer on surface of the alloy substrate and obtain an anodized alloy substrate. The alloy substrate is a metal alloy and the anodized alloy substrate has irregularities on surface. Thereafter, a coating layer is applied on the surface of the alloy substrate to smoothen the surface by providing a uniform covering on the irregularities of the surface. After applying the coating layer, an exterior coat is deposited on the surface of the alloy substrate.

### BACKGROUND

Metal alloys are generally used for different applications ranging from medical devices to commercial and industrial materials. The metal alloys exhibit a wide variety of characteristics that make them suitable for such applications. The type of characteristics exhibited by a metal alloy is determined by the constituents of the metal alloy.

The characteristics of the metal alloys can be customized during manufacturing of the metal alloys, depending upon composition of the alloy, and process used for manufacturing of such metal alloys.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a sectional view of a metal alloy ingot with a coating layer deposited on surface of the metal alloy ingot, in accordance with an implementation of the present subject matter;

FIG. 2 illustrates different stages of processing an alloy substrate for depositing a coating layer, according to an implementation of the present subject matter;

FIG. 3 illustrates an example method for depositing a coating layer on an alloy substrate, according to an implementation of the present subject matter; and

FIG. 4 illustrates an example method for coating an alloy substrate for housing of an electronic device, according to an implementation of the present subject matter.

### DETAILED DESCRIPTION

Generally, alloys of metals such as aluminum, and magnesium are anodized to form a corrosion-resistant oxide layer over the metal alloys. Anodization also provides adhesiveness to surfaces of the metal alloys for adherence with exterior coats, such as colored paints or metallic coats. Such anodized metal alloys having exterior coats may be used for various applications, in housings and back covers for devices, such as mobile phones and laptops.

The anodized metal alloys generally have irregularities, such as protrusions, lumps, and other deformities, for instance grooves, cracks, pores and cavities on the surfaces. The surfaces, with such irregularities, are non-uniform and uneven, and generally resistant towards being coated with other materials. Consequently, exterior coats applied on such surfaces have non-uniform and uneven deposition with reduced adhesion and durability. Such exterior coats may degrade appearance of the anodized metal alloys and may also affect usage of the anodized metal alloys in different end applications.

In accordance with an implementation of the present subject matter, techniques for providing uniform and durable exterior coats on a surface of a metal alloy are described. The techniques provide a uniform covering on irregularities of the surface to make the surface smooth and stable for adhering with exterior coats.

In an example implementation of the present subject matter, an alloy substrate may be selected in accordance with an application of the alloy substrate. The alloy substrate may be selected based on characteristics of the alloy substrate. For instance, a light and a durable alloy substrate may be selected for the purpose of manufacturing housing and covers for electronic devices. In an example, the alloy substrate is a metal alloy, obtained through casting or molding of molten metal alloy in a die or a mold, and then cooling and solidifying the molten metal alloy. The surface of the alloy substrate is reactive with gases and moisture in the environment.

In an example implementation of the present subject matter, the alloy substrate may be subjected to an electrochemical process of anodizing to form a metal oxide layer on the surface and obtain an anodized alloy substrate. The metal oxide layer covers the surface and prevents the anodized alloy substrate from corrosion and reaction with gases and moisture in the environment. As mentioned above, the anodized alloy substrate may include irregularities, such as lumps, grooves, pores, and cavities on the surface.

In an example implementation, a coating layer is applied on the surface of the anodized alloy substrate. The coating layer may be a transparent or a translucent resin layer, to provide a smooth and uniform surface for the anodized alloy substrate. In an example, the coating layer provides a uniform covering over the pores, the cavities and the lumps thereby making the surface even and smooth. The coating layer also enhances adhesion of the surface with exterior coats. Therefore, exterior coats deposited on the surface exhibit enhanced durability and adhesion with the surface.

After applying the coating layer, an exterior coat is deposited on the surface of the anodized alloy substrate. The exterior coat may be a paint coat or a metal coat having a design or a pattern, for instance to provide an appearance of a logo, on the anodized alloy substrate. In an example, the design or the pattern is obtained by utilizing a mask during deposition of the exterior coat. The mask has a surface pattern and is placed over the anodized alloy substrate during the deposition. The surface pattern of the mask allows exposure of some portions of the surface and covers remaining portions of the surface such that the exterior coat is deposited on the exposed portions of the surface. Accordingly, the exterior coat deposited on the surface has a pattern based on the surface pattern of the mask. In an example, the exterior coat may be deposited through a vapor deposition technique, such as Physical Vapor Deposition (PVD).

Thus, the described techniques of depositing the coating layer provide efficient techniques for making surface of an anodized alloy substrate smooth and even to facilitate uniform deposition of exterior coats. Further, the exterior coats deposited on the surface exhibit enhanced adhesion and durability. The techniques provide a time and resource efficient mechanism of removing the irregularities and making the surface smooth and even.

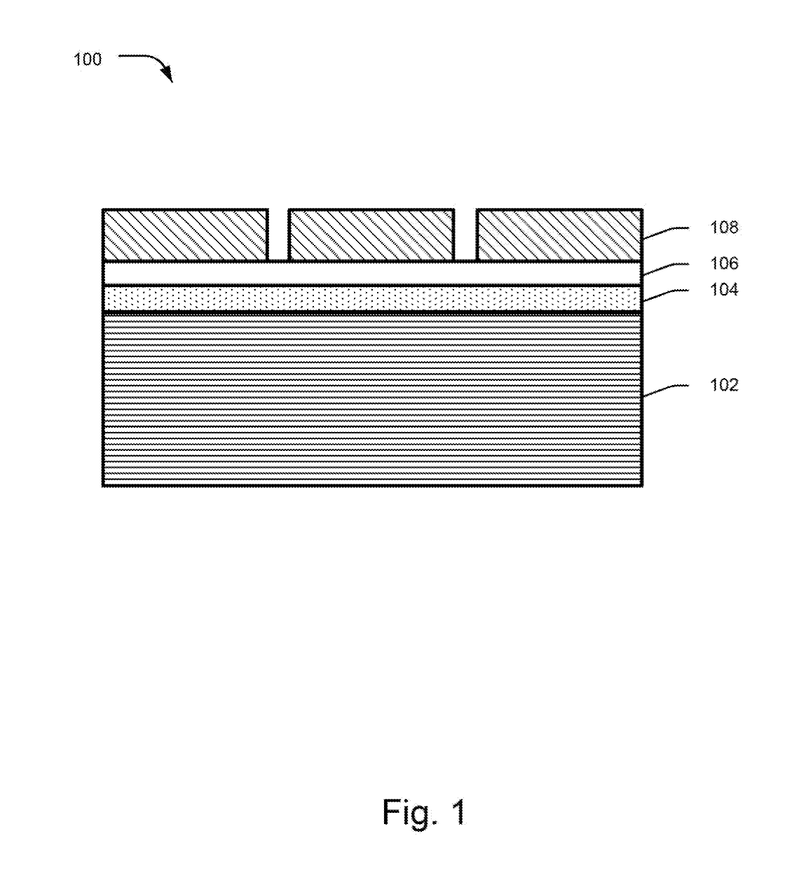

The above described techniques are further described with reference to FIGS. 1 to 4. It should be noted that the description and figures merely illustrate the principles of the present subject matter along with examples described herein and, should not be construed as a limitation to the present subject matter. It is thus understood that various arrangements may be devised that, although not explicitly described or shown herein, describe the principles of the present subject matter. Moreover, all statements herein reciting principles, aspects, and examples of the present subject matter, as well as specific examples thereof, are intended to encompass equivalents thereof.

FIG. 1 illustrates a sectional view of a metal alloy ingot 100 with an exterior coat deposition, according to an implementation of the present subject matter. The metal alloy ingot 100, has a uniform surface that is adhered to the exterior coat and provides durability to the exterior coat. The uniform surface is obtained by subjecting an alloy substrate 102 to anodizing and application of a coating layer, as per techniques described with reference to subsequent figures.

Referring to FIG. 1, the alloy substrate 102 is composed of a metal alloy, for example, an aluminum alloy or a magnesium alloy. The alloy substrate 102 may be fabricated through techniques of manufacturing alloys, such as molding or die-casting of the metal alloy using a die wherein a molten metal alloy is poured and then allowed to cool to take the shape of the die.

The metal alloy ingot 100 has a metal oxide layer 104 deposited over the alloy substrate 102. The thickness of the metal oxide layer 104 may be within the range of 5-15 micrometer (μm). In an example, the metal oxide layer 104 is obtained by anodizing the surface of the alloy substrate 102. The metal oxide layer 104 provides durability to the surface of the alloy substrate 102 and insulates the surface from the outside environment, thereby reducing reactivity and corrosion of the surface. In an example, the surface of the metal alloy ingot 100, with the metal oxide layer 104, has irregularities such as lumps, grooves, cracks and pores. The irregularities make the surface uneven and non-uniform and reduce adhesion and durability of exterior coats deposited on the surface.

In an example implementation, the metal alloy ingot 100 includes a coating layer 106. In an example, the coating layer 106 is composed of one of an epoxy, acrylic, polyurethane, polycarbonate, and polyester material. In another example, the thickness of the coating layer 106 is within the range of about 5-25 μm. The coating layer 106 provides a uniform and smooth surface to the metal alloy ingot 100 by covering the pores, cavities, cracks and lumps of the surface. Further, the coating layer 106 facilitates adhesion of the surface with exterior coats.

The metal alloy ingot 100 includes an exterior coat 108 disposed on the coating layer 106. The exterior coat 108 may be a paint coat to provide a color and a texture to the surface or a metallic coat to provide lustrous appearance to the surface. In an example, the exterior coat 108 may include a pattern or a design to provide an appearance of a logo on the alloy substrate 102. The pattern of the exterior coat 108 may be obtained by utilizing a mask (not shown in the figure) during deposition of the exterior coat 108. The metal alloy ingot 100 with the exterior coat having such a pattern may be used for applications in electronic devices, such as on back covers and housings for laptops, notebooks, and smartphones.

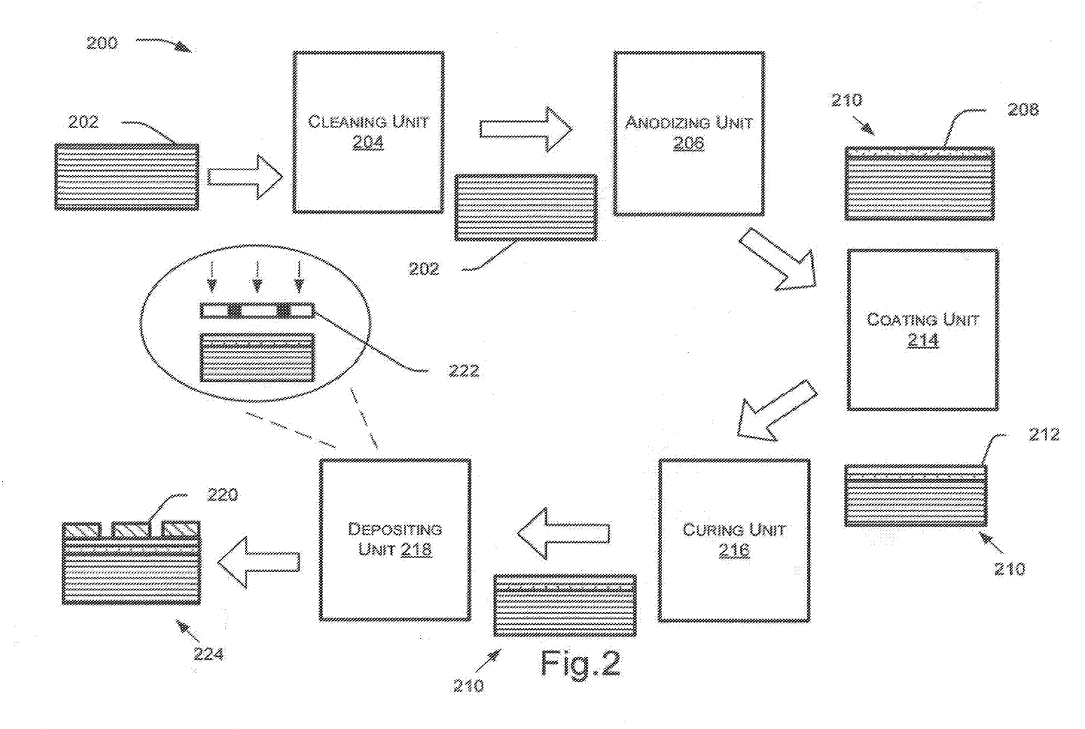

The details of various stages of processing the alloy substrate 102 to apply the coating layer 106 on the surface and depositing the exterior coat 108 have been explained in conjunction with description of FIG. 2.

FIG. 2 illustrates various stages 200 of processing a metal alloy, implemented by various units, for depositing a coating layer on the metal alloy, according to an example implementation of the present subject matter. For sake of explanation, each stage of the process has been described with reference to an alloy substrate 202. A unit, in context of the present description, can be an apparatus, a machine or a combination of apparatuses or machines for performing an operation at a stage. At different stages, different units interact with the alloy substrate 202 to process the alloy substrate 202 or add different layers over the surface of the alloy substrate 202 to create a metal alloy ingot, such as the above-described metal alloy ingot 100.

In an example implementation, the alloy substrate 202 is obtained for exterior coat deposition. The alloy substrate 202 is initially cleaned by a cleaning unit 204 to eliminate dust particles and impurities from surface of the alloy substrate 202. In an example, the cleaning unit 204 may have a container with a cleaning solution, such as a sodium hydroxide (NaOH) solution. The alloy substrate 202 may be dipped into the container with the cleaning solution and then washed with an acid, such as hydrochloric acid (HCl) or nitric acid. In an example, the cleaning unit 204 performs chemical polishing of the alloy substrate 202 using acids, such as hydrochloric acid, nitric acid, phosphoric acid and sulfuric acid. After performing the chemical polishing, the cleaning unit 204 may wash the alloy substrate 202 with one of hydrochloric acid and nitric acid.

After cleaning the surface, the alloy substrate 102 is subjected to an electrochemical process of anodizing by an anodizing unit 206. In an example, the anodizing unit 206 may be an electrochemical cell having an electrolyte for performing an electrochemical reaction on the alloy substrate 202. In the electrochemical process, the alloy substrate 202 may be used as anode and electric current may be passed through the electrolyte to release oxygen from the electrolyte. The oxygen reacts with the anode or the alloy substrate 202 to form a metal oxide layer 208 on the alloy substrate 202. In an example, the anodizing unit 206 may perform anodizing at a voltage range of about 10-60 Volts (V) and at a temperature range of about 15-25 centigrade (° C.). In another example, the anodizing unit 206 may anodize the alloy substrate 202 for a duration of about 30-50 minutes.

The anodizing is performed to make the surface durable and corrosion-resistant. After the anodizing, an anodized alloy substrate 210, including the alloy substrate 202 and the metal oxide layer 208, is obtained. The surface of the anodized alloy substrate 210 may have various irregularities, such as lumps, grooves, cracks and pores. Such irregularities make the surface non-uniform and resistant towards coating with exterior coats. As would be understood, the anodized alloy substrate 210 may have the irregularities on the surface based on non-uniform reaction of oxygen with the alloy substrate and uneven formation of metal oxide during the electrochemical process of anodizing.

The anodized alloy substrate 210 is then coated with a coating layer 212 by the coating unit 214. For example, the coating unit 214 may include a spraying apparatus or multiple spraying apparatuses for spraying coating material on the anodized alloy substrate 210. The coating material can be one of an epoxy material, acrylic material, polyurethane material, polycarbonate material, and polyester material. In an example, the coating unit 214 may coat the surface of the anodized alloy substrate 210 with an Ultraviolet (UV) coating layer. The coating unit 214 may include a heating apparatus, such as an oven and a UV exposure unit. For coating with the UV coating layer, the coating unit 214 may bake the anodized alloy substrate 210 at a temperature of about 50-60° C. for a duration of about 10-15 minutes and then expose the surface to UV radiations. In an example, the UV exposure may be performed at about 700-1,200 millijoules per centimeter square (mJ/cm²).

The UV coating layer deposited over the surface may be one of a transparent and a translucent coating to provide smoothness and uniformity to the surface. In an example, the UV coating layer is composed of resins, such as polyurethane, polycarbonate, urethane acrylates, polyacrylate, polystyrene, polyetheretherketone, polyesters, fluoropolymers, and mixture of at least two constituents.

The coating unit 214 applies the coating layer 212 on the surface such that the pores and cavities are covered and the surface becomes even and smooth. In an example, the coating material may be filled in the pores, cracks, and grooves to level the surface and make the surface even and smooth. Such a smooth surface facilitates deposition of the exterior coat with ease and enhances adhesion of the surface with exterior coats, and paint primers.

In an example, the coating layer 212 may seal the surface of the anodized alloy substrate 210 to provide enhanced adhesion with colored exterior coats, such as dyes and prevent fading of the colored exterior coats from the surface. After applying the coating layer by the coating unit 214, the anodized alloy substrate 210 with the coating layer 212 as the top most layer is obtained.

After applying the coating layer 212, the anodized alloy substrate 210 is subjected to curing, implemented by a curing unit 216. The curing unit 216 may be a heating oven for baking the anodized alloy substrate 210 at a high temperature. For instance, the anodized alloy substrate 210 may be heated at a temperature of about 60-120° C. for a duration of about 20-40 minutes. The baking of the anodized alloy substrate 210 allows uniform settling of the coating layer 124 on the surface and enhances adhesion of the surface with exterior coats.

In an example implementation, an exterior coat 220 may then be deposited on the anodized alloy substrate 210 by the deposition unit 218. The deposition unit 218 may be a vapor deposition unit for performing Physical Vapor Deposition (PVD) on the surface of the anodized alloy substrate 210. In the PVD, a physical process, such as heating or sputtering is used to produce gaseous form or vapor of the exterior coat and the vapor is deposited on the anodized alloy substrate 210. Upon cooling, the deposited vapor may condense and form the exterior coat on the surface of the anodized alloy substrate 210. In an example, the deposition unit 218 may deposit the exterior coat 220 under vacuum condition of about 0.1-10 millitorr (mTorr) and perform plasma cleaning for 1-3 minutes. During plasma cleaning, impurities and contaminants are removed from the surface by using plasma, generated by using high frequency voltages to ionize gases, such as argon and oxygen. Thereafter, the deposition unit 218 may deposit the exterior coat 220 at a temperature of 120-150° C. for a duration of about 5-15 minutes.

In an example, the exterior coat 220 may be composed of material of one of titanium, chromium, nickel, zinc, zirconium, manganese, copper, aluminum, tin, molybdenum, tungsten, tantalum, tungsten, hafnium, gold, vanadium, silver, platinum, and graphite. The deposition unit 218 may utilize different PVD techniques, such as one of ion beam sputtering, reactive sputtering, ion assisted deposition, high-target utilization sputtering, high power impulse magnetron sputtering, gas flow sputtering to deposit the exterior coat 220.

In an example implementation, a mask 222 is placed over the surface of the anodized alloy substrate 210 during deposition of the exterior coat 220. The mask 222 has a surface pattern that allows some portions of the surface to be exposed for deposition and covers remaining portions of the surface to prevent deposition of the exterior coat on such covered portions. Therefore, the exterior coat 220 deposited on the surface has a pattern based on the surface pattern of the mask 222. The mask 222 with the surface pattern may be selected based on a pattern of the exterior coat to be deposited on the anodized alloy substrate 210. The pattern of the exterior coat may depend upon type of application, such as type and design of logo used on housings and back covers of electronic devices. In an example, after depositing the exterior coat 220, the anodized alloy substrate 210 may be subjected to curing at a temperature of about 150-180° C.

After depositing the exterior coat 220 by the coating unit 218, a metal alloy ingot 224 having the substrate alloy 202 with the exterior coat 220 as the top most layer is received. Thus, the described techniques provide for a process including anodizing the surface and depositing a coating layer to reduce porosity and reactivity of the alloy substrate 202 and to make the surface smooth and stable for adhesion with exterior coats.

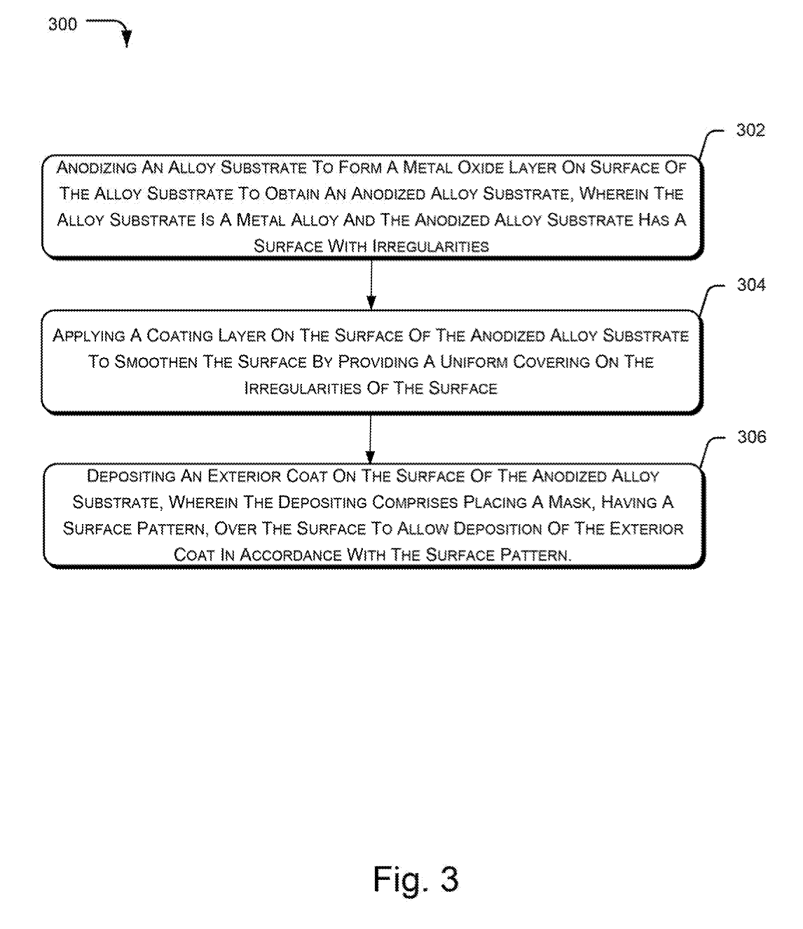

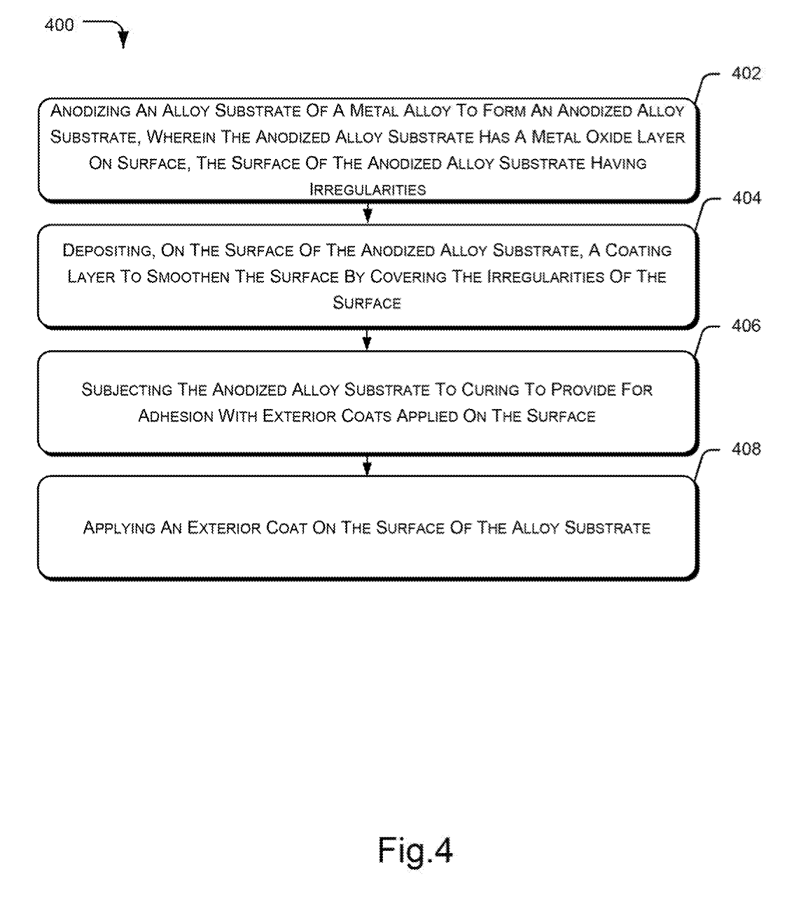

FIG. 3 and FIG. 4 illustrate methods 300 and 400 for processing a metal alloy for deposition of coating layers. The order in which the methods 300 and 400 is described is not intended to be construed as a limitation, and any number of the described method blocks may be combined in any order to implement the methods 300 and 400, or an alternative method.

FIG. 3 illustrates the method 300 for processing an alloy substrate of the metal alloy for deposition of a coating layer, according to an example implementation of the present subject matter. Alloy substrates are generally anodized to make the surface durable and corrosion-resistant. However, the surface of the anodized alloy substrate generally has irregularities, such as lumps, grooves, cracks, and pores that makes the surface uneven and resistant towards coating with different materials. To remove the irregularities and make the surface stable for adhesion with exterior coats, the alloy substrate is subjected to various process steps, as described herein.

At block 302, anodizing of the alloy substrate is performed to form a metal oxide layer on the surface of the alloy substrate and obtain an anodized alloy substrate. The alloy substrate is a metal alloy and the anodized alloy substrate has a surface with the irregularities. The metal oxide layer provides durability to the surface and reduces reactivity of the alloy substrate. In an example implementation, the anodizing is performed by the anodizing unit 206 on the alloy substrate 202 to form the metal oxide layer 208.

Thereafter, a coating layer is applied to the surface of the anodized alloy substrate, at block 304. The coating layer makes the surface smooth and even by providing a uniform covering on the irregularities. Thereafter, at block 306, the exterior coat is deposited on the surface of the anodized alloy substrate by utilizing a mask. The mask is placed over the surface during deposition and has a surface pattern that exposes some portions of the surface for deposition. Therefore, the exterior coat deposited on the surface has a pattern in accordance with the surface pattern of the mask.

In an example implementation, the mask 222 is utilized for deposition of the exterior coat 220. The alloy substrate 202 with the exterior coat 220 is a metal alloy ingot, such as the above-described metal alloy ingot 100 and 224. The metal alloy ingot as obtained by the described method, may be used for various purposes where an anodized alloy substrate with a uniform and even surface having high adherence to exterior coating is desired.

FIG. 4 illustrates the method 400 for coating an alloy substrate used in housing of an electronic device, according to an example implementation of the present subject matter. For example, the alloy substrate may be coated for use in manufacturing back covers and housing for electronic devices, such as laptops and smart phones.

At block 402, anodizing of the alloy substrate is performed to obtain an anodized alloy substrate. The anodized alloy substrate includes a metal oxide layer on the surface. The alloy substrate is a metal alloy and the surface of the anodized alloy substrate has irregularities. As would be understood, the anodized alloy substrate may have the irregularities on the surface based on non-uniform reaction of oxygen with the alloy substrate and uneven formation of metal oxide during the electrochemical process of anodizing. At block 404, a coating layer is deposited on the anodized alloy substrate to make the surface smooth and even by covering the irregularities of the surface. In an example, the coating layer may be a transparent or a translucent resin layer that provides smooth texture to the surface and enhances adhesion of the surface with exterior coats.

Thereafter, at block 406, the anodized alloy substrate is subjected to curing to provide for adhesion with exterior coats applied on the surface. During curing, the alloy substrate is baked in a heating oven to allow the coating layer to settle on the surface of the alloy substrate. In an example implementation, the anodized alloy substrate 210 is cured by the curing unit 216. At block 408, an exterior coat is applied on the surface of the alloy substrate. In an example, the exterior coat may be deposited using a vapor deposition technique, such as a PVD technique.

Therefore, the described techniques efficiently provide a smooth and even surface that facilitates uniform deposition of exterior coats thereby enhancing adhesion and durability of the exterior coats.

Although implementations of present subject matter have been described in language specific to structural features and/or methods, it is to be understood that the present subject matter is not necessarily limited to the specific features or methods described. Rather, the specific features and methods are disclosed and explained in the context of a few implementations for the present subject matter.

What is claimed is:

1. A method comprising:
anodizing an alloy substrate to form a metal oxide layer on surface of the alloy substrate to obtain an anodized alloy substrate, wherein the alloy substrate is a metal alloy and the anodized alloy substrate has a surface with irregularities;
applying a coating layer on the surface of the anodized alloy substrate to smoothen the surface by providing a uniform covering on the irregularities of the surface;
depositing an exterior coat on the surface of the anodized alloy substrate, wherein the depositing comprises placing a mask, having a surface pattern, over the surface to allow deposition of the exterior coat in accordance with the surface pattern.

2. The method as claimed in claim 1, wherein the metal alloy is an alloy of at least one of aluminum, and magnesium.

3. The method as claimed in claim 1, wherein the exterior coat is deposited based on a Physical Vapor deposition (PVD) technique.

4. The method as claimed in claim 3, wherein the PVD technique comprises at least one of Ion-Beam Sputtering (IBS), High-Power Magnetron Sputtering (HIPIMS), and gas flow sputtering.

5. The method as claimed in claim 1 comprising subjecting the alloy substrate to a surface cleaning process for eliminating impurities and dust from the surface of the alloy substrate for anodizing.

6. A method for coating an alloy substrate for a housing of an electronic device, the method comprising:
anodizing an alloy substrate of a metal alloy to obtain an anodized alloy substrate, wherein the anodized alloy substrate has a metal oxide layer on surface, the surface of the anodized alloy substrate having irregularities;
depositing, on the surface of the anodized alloy substrate, a coating layer to smoothen the surface by covering the irregularities of the surface;
subjecting the anodized alloy substrate to curing to provide for adhesion with exterior coats applied on the surface;
applying an exterior coat on the surface of the alloy substrate.

7. The method as claimed in claim 6, wherein the exterior coat is deposited by utilizing a mask having a surface pattern to allow deposition of the exterior coat on the surface based on the surface pattern.

8. The method as claimed in claim 7, wherein the exterior coat is deposited through a Physical Vapor Deposition (PVD) technique.

9. The method as claimed in claim 6, wherein the exterior coat is of one of titanium, chromium, nickel, zinc, zirconium, manganese, copper, aluminum, tin, molybdenum, tantalum, tungsten, hafnium, gold, vanadium, silver, platinum, and graphite.

10. The method as claimed in claim 6 comprising subjecting the alloy substrate to a surface cleaning process for eliminating impurities and dust from the surface of the alloy substrate.

11. A metal alloy ingot comprising:
an alloy substrate;
a metal oxide layer on the alloy substrate, the metal oxide layer formed through an anodizing process, wherein the alloy substrate with the metal oxide layer has a surface with irregularities;
a coating layer on the metal oxide layer to smoothen the surface by providing a covering on the irregularities of the surface; and
an exterior coat on the coating layer, wherein the exterior coat comprises a pattern.

12. The metal alloy ingot as claimed in claim 11, wherein the metal alloy is an alloy of at least one of aluminum, and magnesium.

13. The metal alloy ingot as claimed in claim 11, wherein the exterior coat is deposited based on a Physical Vapor deposition (PVD) technique.

14. The metal alloy ingot as claimed in claim 13, wherein the PVD technique comprises at least one of Ion-Beam Sputtering (IBS), High-Power Magnetron Sputtering (HIPIMS), and gas flow sputtering.

15. The metal alloy ingot as claimed in claim 13, wherein the exterior coat is one of titanium, chromium, nickel, zinc, zirconium, manganese, copper, aluminum, tin, molybdenum, tantalum, tungsten, hafnium, gold, vanadium, silver, platinum, and graphite.
